(19) United States
(12) Patent Application Publication
(10) Pub. No.: US 2012/0204488 A1
(43) Pub. Date: Aug. 16, 2012

(54) PLANT CONTAINER WITH RIGIDLY REVERSIBLY ATTACHABLE CANOPY TRAINING RACK

(76) Inventor: George Anderson, Portland, OR (US)

(21) Appl. No.: 13/029,100

(22) Filed: Feb. 16, 2011

(51) Int. Cl. A01G 9/02

(52) U.S. Cl. 47/66.6

(57) ABSTRACT

The invention is a plant container with a rigidly reversibly attachable canopy training rack. Plant container and canopy training rack are specifically designed to maximize fruit or vegetable production from a plant, where maximization is done through setting the size and shape of the canopy and root systems of the plant. Further, plant container and canopy training rack are design to create a plant that is sized to be about the maximum size plant that can be easily managed and moved by one average sized adult person. Canopy training rack is reversibly and rigidly attachable to the plant container. The invention provides the capability to grow plants in an area that is without access to ground soil, such as a balcony, porch, patio, sidewalk, deck, or other. Invention does not include soil or growing material. Invention does not include a light source so the plant must be placed in a sunny area or other lighted area in order for the plant to grow.

### BACKGROUND OF THE INVENTION

1. Field of the Invention

Vegetable or fruit yields from plants may be increased with proper canopy management. The canopy of a plant is the portion of the plant located above the ground such as the trunk, branches, stems, vines, leaves, foliage, flowers, vegetables, or fruit. The portion of a plant located below the ground is called the root system. A plant's canopy plays a key role in the plant's photosynthesis process or growing process because the leaves or other portions of the canopy are where photosynthesis occurs. The process of photosynthesis uses light and other inputs to produce more plant material, namely more canopy or foliage, which results in increased production of vegetables or fruit in the canopy as well. Thus, photosynthesis plays a key role in the overall fruit or vegetable production process of a plant.

Canopy management involves finding the best balance with enough leaves or foliage to facilitate and increase photosynthesis and fruit or vegetable production without reaching the point of excessive shading from the leaves or foliage that could impede fruit or vegetable production, impede fruit or vegetable ripening, or promote disease of the plant, fruit, or vegetable. Also, there is another excessive point of canopy growth where the canopy grows to a size that is beyond the root's capability to physically hold up the plant. If the canopy grows to a size beyond this point, the plant may fall over, typically leading to total failure of fruit or vegetable production.

This invention comprises a specifically designed plant container or flowerpot and specifically designed canopy training rack or trellis that mates with the plant container to form an integrated assembly of plant container and canopy training rack. Canopy training rack is a rigid structure that is reversibly attachable to the plant container by a rigid connection means.

Canopy training rack is designed to promote a certain shaped and sized canopy that tends to optimize fruit or vegetable yields. Canopy training rack is also designed to sturdily physically support the canopy above its root system. Additionally, the certain canopy shape and size promoted by the canopy training rack produces a plant that is easily managed by one average sized adult where such manageability includes the ability to lift and move the whole assembly with the plant inside simply by handling or lifting the canopy training rack portion which is the upper most portion of the invention when the canopy training rack is rigidly attached to the plant container.

Plant container is deigned with a specifically sized and shaped soil space that is designed to promote root growth or a root system to complement or encourage the canopy and the root system to quickly grow to reach their optimum size for vegetable or fruit production and to maintain this size. Plant container is designed to mate with canopy training rack to form a rigid sturdy connection that is reversible.

Additionally, the invention is designed to conveniently grow fruits and vegetables in a small space that is without access to ground soil such as on a balcony, porch, patio, sidewalk, deck, and similar.

2. Description of Related Art

There are many plant containers or flowerpots in the public domain. Additionally, there are many plant racks designed to support a plant's canopy in the public domain. However, no combination of these has the characteristics of plant and soil container designed to produce a specific sized and shaped root system along with a rigidly reversibly attachable canopy training rack designed to produce a specific sized and shaped canopy that matches the specific sized and shaped root system where the overall design maximizes flower or fruit production of the overall device that is sized to be managed and moved by one typical adult person in a small area that is without ground soil.

### BRIEF SUMMARY OF THE INVENTION

The invention is a plant container with a rigidly reversibly attachable canopy training rack. Plant container and canopy training rack are specifically designed to maximize fruit or vegetable production from a plant, where maximization is done through setting the size and shape of the canopy and root systems of the plant. Further, plant container and canopy training rack are design to create a plant that is sized to be about the maximum size plant that can be easily managed and moved by one average sized adult person. Canopy training rack is reversibly and rigidly attachable to the plant container. Plant container design includes the proper size and shape to complement that of the canopy training rack and vice versa. The invention provides the capability to grow plants in an area that is without access to ground soil, such as a balcony, porch, patio, sidewalk, deck, or other. Invention does not include soil or growing material. Invention does not include a light source so the plant must be placed in a sunny area or other lighted area in order for the plant to grow.

### BRIEF DESCRIPTION OF THE DRAWINGS

FIG. 1 is a front elevation view of best mode.

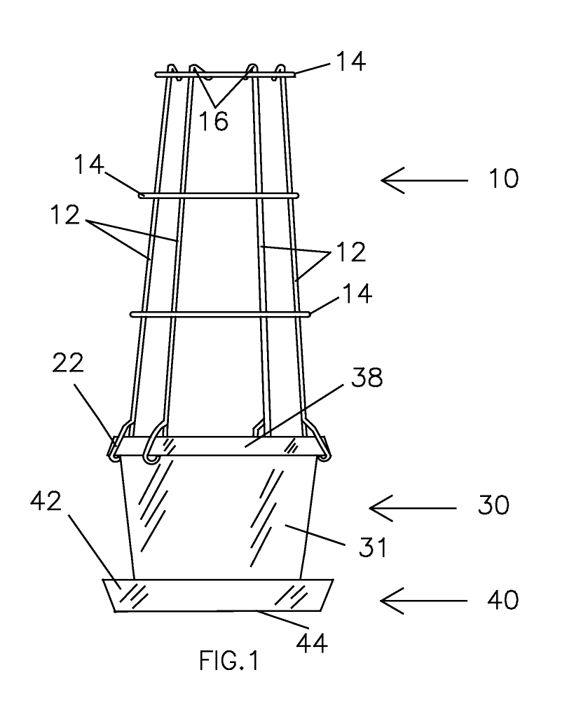

FIG. 2 is a front perspective view of best mode.

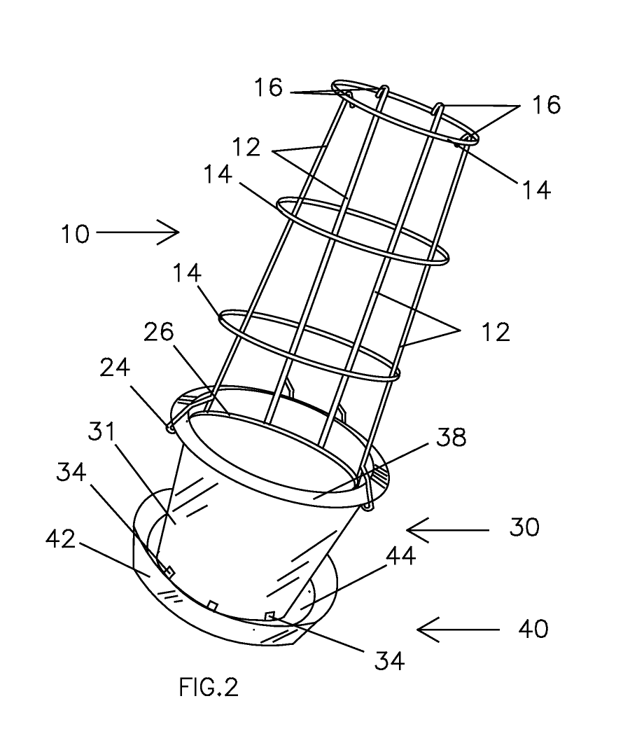

FIG. 3 is a top perspective view of best mode.

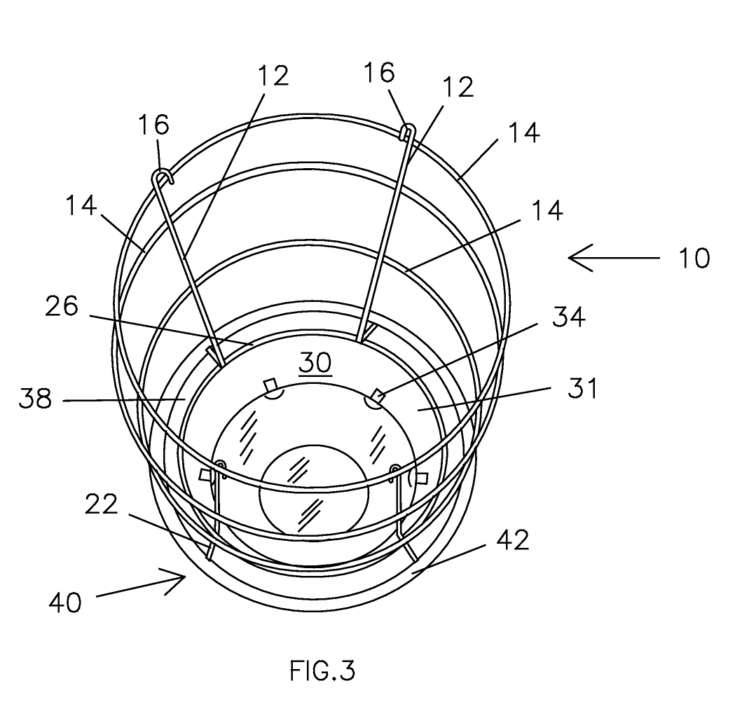

FIG. 4 is a bottom perspective view of best mode.

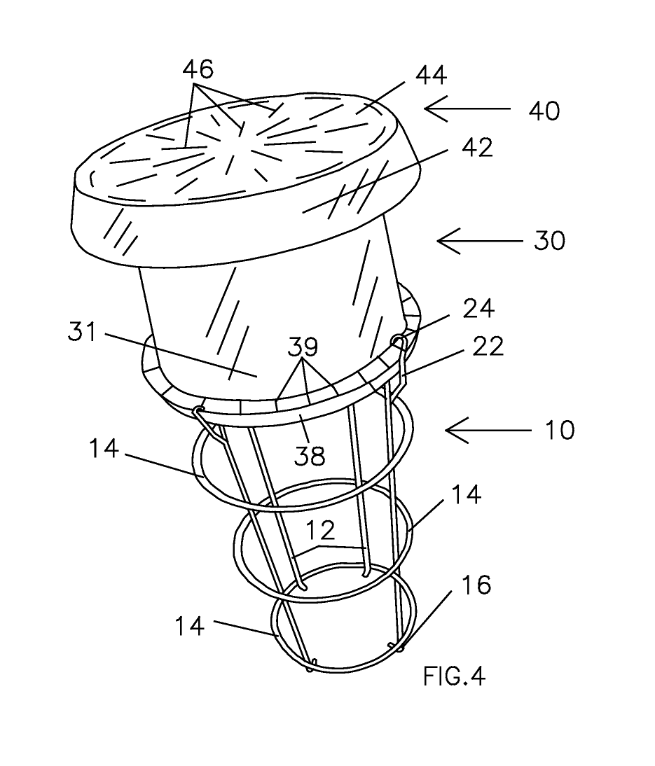

FIG. 5 is a front elevation view of best mode with a plastic bag installed over the top of the device to create a mini-greenhouse or plant warming/vapor-retaining mini-environment.

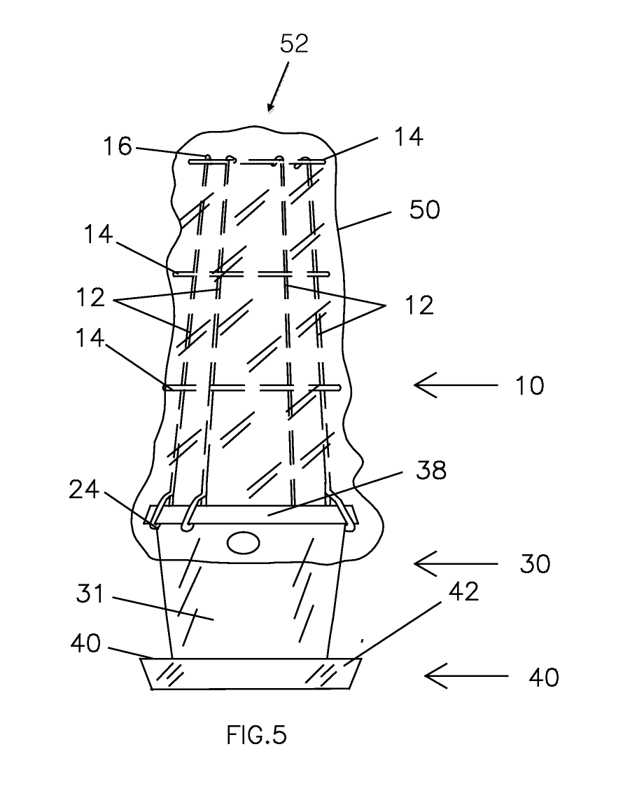

FIG. 6 is a front elevation view of best mode with cross-sectional blow-up of the canopy training rack's plant container connection means.

FIG. 7 is a top plan view of best mode defining cross sectional plane A-A.

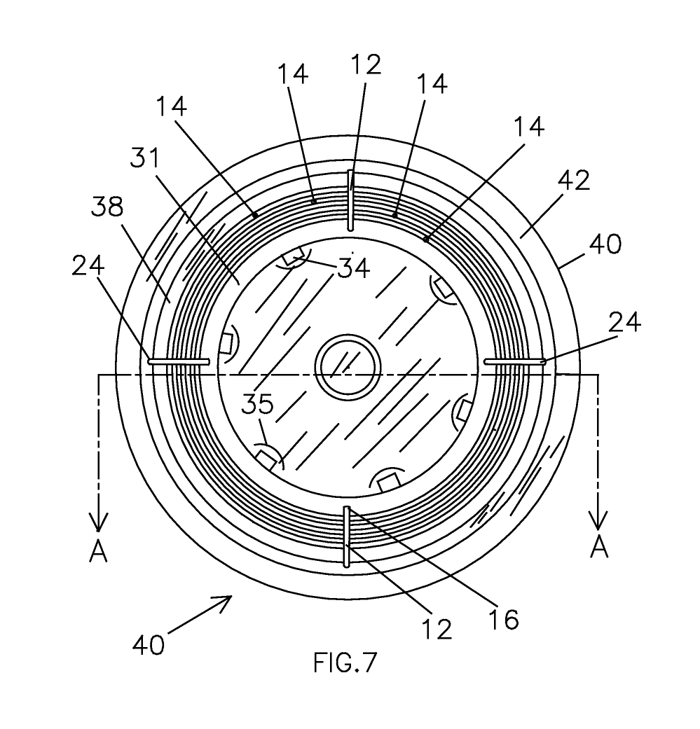

FIG. 8 is a bottom plan view of best mode.

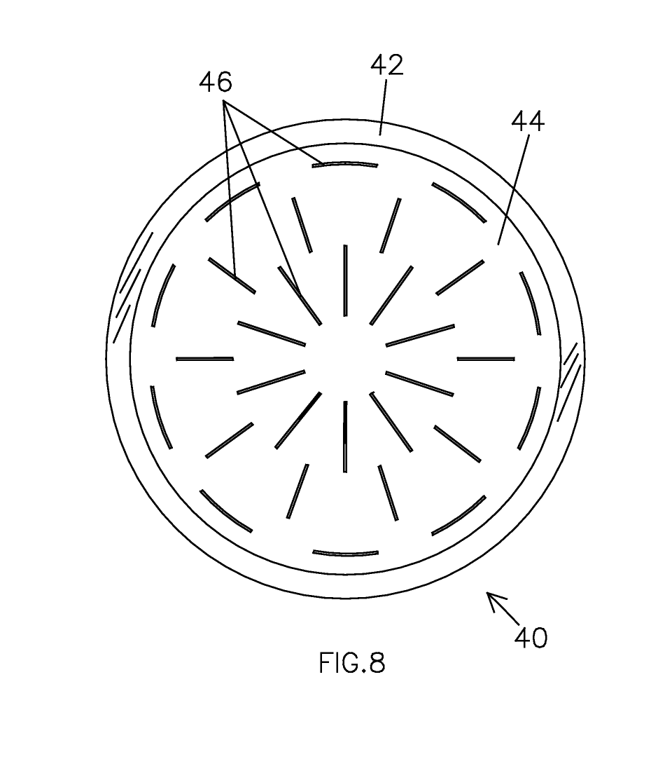

FIG. 9 is a cross sectional view of plane A-A.

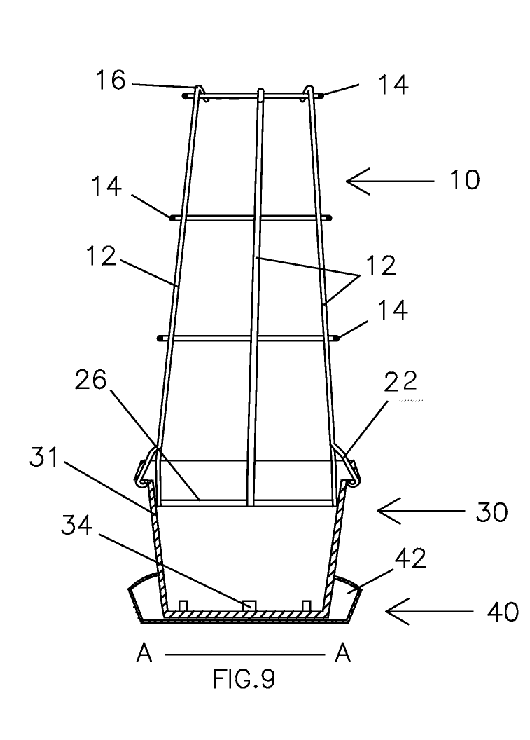

FIG. 10 is a blow-up cross sectional view of the canopy training rack's plant container connection means.

FIG. 11 is an exploded front elevation view of best mode defining cross sectional plane B-B.

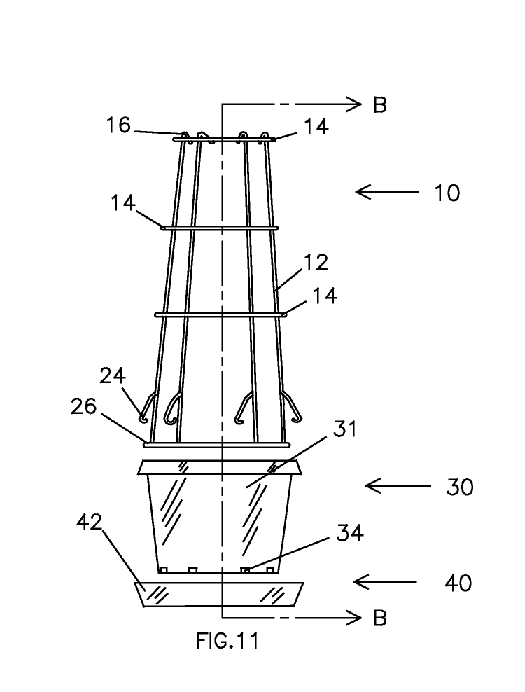

FIG. 12 is a cross sectional view of plane B-B.

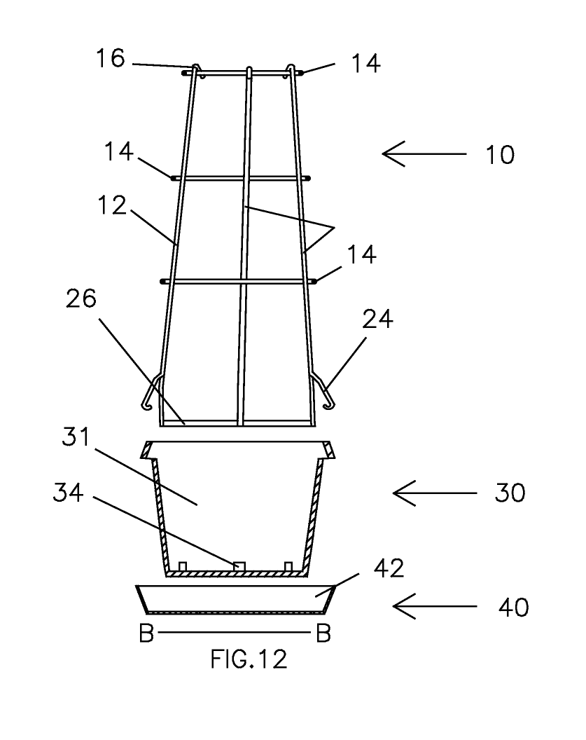

### DEFINITION LIST

| Term | Definition |
|---|---|
| 10 | Canopy Training Rack |
| 12 | Vertical Support Members |
| 14 | Horizontal Support Members |
| 16 | Plastic Cover Dome Support Members |
| 20 | Plant Container Connection Means |
| 22 | Wide Brim Parallel Member |
| 24 | Hook Member |
| 25 | Wide Brim Parallel Member Attachment Means |
| 26 | Clamp Ring |
| 28 | Clam Ring Attachment Means |
| 30 | Plant Container |
| 31 | Cylindrical Conical Member |
| 32 | Bottom |
| 34 | Water Drainage Holes |
| 35 | Soil Retention Ridges |
| 38 | Wide Brim |
| 39 | Wide Brim Support Ridges |
| 40 | Water Saucer |
| 42 | Water Saucer Cylindrical Conical Member |
| 44 | Water Saucer Bottom Member |
| 46 | Water Saucer Bottom Ridges |
| 50 | Plastic Bag |
| 52 | Dome Area |

### DETAILED DESCRIPTION OF THE INVENTION

Most plants may be broken down into two main components: the root system and the canopy of the plant. The root system is the part of the plant that typically lies below the ground. The two main functions of the root system are to physically support the canopy portion of the plant above the ground and to absorb water and nutrients from the soil or growing medium around the root system for the plant. The canopy of the plant is the part of the plant that typically stands above the ground. The plant trunk, branches, stems, vines, leaves, foliage, flowers, vegetables, and fruit are part of the canopy portion of the plant.

A plant's canopy plays a key role in the plant's photosynthesis process or growing process because the leaves or other portions of the canopy are where photosynthesis takes place for the plant. The process of photosynthesis uses light shining down onto of the canopy of the plant and combines this light with other ingredients to chemically produce new plant material or plant growth mainly in the form of increased size of volume of the plant canopy and root system. Increased photosynthesis logically results in increased production of vegetables or fruit in the canopy. Thus, photosynthesis plays a key role in the fruit or vegetable production process of a plant. Canopy management involves finding the best balance with enough leaves or foliage to facilitate and increase photosynthesis and fruit or vegetable production without reaching the point of excessive growth or excessive shading of the leaves or foliage that could: impede fruit or vegetable production, impede fruit or vegetable production ripening, or promote disease of the plant, fruit, or vegetable. Also, the canopy cannot extend beyond the root's capability to physically hold up the plant. If the canopy grows to a size beyond this point, the plant may fall over, typically leading to total failure of fruit or vegetable production.

The size of the canopy affects the size of the root system of a plant and vice versa. Limitation of the root system may lead to limitation of the canopy of the plant. Limitation of the canopy may lead to limitation of the root system of the plant.

It is ideal for the root system and the canopy of the plant to form into generally spherical shapes with the canopy sphere standing above ground and the root system sphere lying below ground. In order to maximize fruit or vegetable production from a single plant, it is ideal for the canopy section of the plant to be given enough space and light to grow to match the same spherical size of the root section of the plant; and, vice versa, it is ideal for the root system of the plant to be given enough space and nutrients to grow to match the same spherical size of the canopy section. Equilibrium between canopy size and root system size tends to lead to increased production of fruit or vegetables. In other words, when the plant is viewed from a top plan view, it is best for fruit or vegetable production if the diameter of the canopy sphere generally matches and aligns with that of the root system below. Put another way, given a limited footprint area available for growth space, fruit or vegetable growth and can be maximized when both root system and canopy are allowed to fill the entire plan view or footprint of the growth space.

This may occur because in nature, when it rains, the canopy acts as an umbrella and most rainwater is delivered to the edge of the canopy. Also, the surface area of the roots in a root system, which is proportional to the rate with which the plant can absorb water and nutrients, increases exponentially with the diameter of the overall root system. So a root system that extends all the way to edge of the canopy absorbs exponentially more water and nutrients than a root system that extends, for instance, all out to 80% of the canopy radius outward from the trunk of the plant. So small differences in this dimension of the root system greatly affect water and nutrient absorption capability of the plant. In any event, it is a principle of this invention that fruit or vegetable production is maximized by training and growing a root system to a size that is about equal to the size of the plant's canopy as referenced from a top plan view of the plant.

Additionally, when the canopy sphere of a plant grows appreciable beyond that of the root system, the plant is in danger of falling over. The deeper a root system grows into the ground, the more holding capacity the root system has to hold up the plant canopy. Again there is typically an equilibrium in nature where the root system extends about as deeply below ground as the canopy extends above ground in order to securely hold the plant upright.

It is also a principle of this invention that the plant and its container must be manageable and moveable by one average sized adult, where the total height of the plant should be about 4-6 feet tall. Best mode overall plant height is about 4.5 feet tall because at this height an averaged sized adult can reach the top of the plant without the need for a stepping stool or ladder. With this overall height objective of 4.5 feet, it was determined that the optimum breakdown of this overall height is about a 3 foot tall section of plant canopy and about a 1.5 foot tall section of root system. Thus, optimum vegetable or fruit production from a 4.5° tall plant per unit of space to keep the plant occurs when the plant has roughly a 1.5° tall root ball and about a 3′ tall canopy.

The specific shape of canopy training rack along with the rigidity of it and its rigid connection to plant container safely allow for a plant to have a taller canopy than root system. Canopy training rack promotes a triangular cross-section canopy or Christmas tree-shaped canopy. The triangular cross-section of the canopy training rack, in effect, elongates the naturally occurring sphere shape of the canopy. The sphere is elongated into cone shape that increases the lateral light absorbing surface area portions of the canopy. A cone has more surface area than a sphere with the same diameter. The increased surface area translates into increased light absorbing capability of the canopy.

The increased size of the canopy does not cause the canopy or plant to fall over because of the sturdy support from the canopy training rack when it is rigidly connected to the plant container. The canopy training rack essentially promotes a 3 foot tall upside down cone shaped canopy and holds this canopy upright thereby allowing for reduction in height of root system and corresponding reduction of the plant container's height without also leading to plant failure by the plant falling over. In this way the invention allows for more vegetable or fruit production that would be natural or possible for the same sized root system. Thus, the invention yields the vegetable or fruit production of a 3 foot diameter root sphere from a root sphere that is merely 1.5 feet in height.

Note however that the width of the root sphere is not constrained by the plant container and is allowed to reach the full width of the canopy sphere. Restriction in this dimension would yield too much of a decrease in water and nutrient absorption from soil because root surface area is reduced exponentially with reduction of root sphere diameter. Water and nutrient absorption, along with light absorption, are directly proportional to vegetable and fruit production of a plant. Thus, the width of the opening on top of the plant container of this invention matches that width of the opening on the bottom of the canopy training rack. This allows the root system to grow to the same width so to speak as that of the canopy above. Thus, the canopy training rack allows for reduction in root sphere height but we do not reduce the width of the root sphere because of the resulting corresponding reduction in water and nutrient absorption.

The invention comprises: a canopy training rack 10, a plant container 30, and a water saucer 40. Canopy training rack comprises: vertical support members 12, horizontal support members 14, plastic cover dome support members 16, and a plant container connection means 20. Vertical support members 12 are straight rigid tubular members that extend vertically upwards from wide brim 38 of the plant container 30 when the canopy training rack 10 is connected to the plant container 30. Vertical support members 12 extend upwards at a slight angle inward towards the vertical centerline of the plant container 30 and canopy training rack 10. The vertical centerline of plant container 30 and canopy training rack 20 coincide with each other when the canopy training rack 10 is properly connected to the plant container 30. Thus, vertical support members 12 together form an upside-down cone shape or Christmas tree shaped cage atop the plant container 30. Vertical support members 12 function to provide mechanical support for the plant canopy branches, stems, vines, leaves, foliage, flowers, vegetables, and/or fruit. Support is provided as the canopy branches, stems, vines, leaves, foliage, flowers, vegetables, and/or fruit start to grow through the cone-shaped cage or vertical support. When this happens, the branches, stems, vines, leaves, foliage, flowers, vegetables, and/or fruit tend to become physically supported by the vertical support members. Support results from the branches, stems, vines, leaves, foliage, flowers, vegetables, and/or fruit growing around, over top of, or otherwise becoming entangled in the support members 12 and 14 of the cage.

Horizontal members 14 are rigid ring shaped members made from the same tubular material as the vertical support members 12. Horizontal support members 14 are permanently and rigidly connected to vertical support members 12 to help form the above referenced upside-down cone-shaped cage of the canopy training rack. Horizontal members 14 are welded, fused, or glued to vertical members 12. Horizontal members lie horizontally at right angles to vertical support members 12. Each horizontal member 14 has a different overall diameter ring shape, where larger diameter horizontal ring members lie below smaller diameter ring members with the largest ring on the bottom and the smallest ring on the top of Canopy training rack 10. Horizontal members 14 are positioned concentrically as viewed from the top of the invention. Horizontal members 14 are positioned outside of vertical members 12 and then permanently connected to each other to form the cone shaped cage. Horizontal members 14 are evenly spaced up the canopy training rack 10. Horizontal overall diameters are evenly spaced up the canopy training rack 10. Vertical members 12 are evenly spaced around the diameter of the cage. Best mode canopy training rack 10 includes three horizontal members 14 and four vertical members 12.

The best mode diameter of the tubular material used to form the support members 12 and 14 is about ⅛-¼″. This diameter material is an optimum size to encourage the plant canopies branches, stems, vines, leaves, foliage, flowers, vegetables, and/or fruit to grow around the support members thereby causing the canopy training rack to support the plant canopy.

Plastic cover dome support members 16 lie on top of vertical support members 12. There is one plastic cover dome support member 16 per vertical support members 12. Plastic cover dome support members 16 function to create a dome area 52 on top of the canopy training rack 10 when a plastic bag 50 is installed over top of the canopy training rack 10. A plastic bag 50 may be installed onto the canopy training rack to create a mini greenhouse 50 around each unit. The plastic bag or greenhouse 50 is used to keep the plant warm and to prevent rapid evaporation of water from the plant and its container. A dome area or convex shape 52 on the top of the plastic bag or greenhouse 50 is necessary to prevent water from rain or condensation or the like from pooling on top of the plastic bag or greenhouse 50. If water pools here it could cause the plastic bag 50 to puncture, leak, or fail which would negate the purposes of using the plastic bag to create the mini greenhouse 50.

Plant container connection means 20 is a reversibly attachable rigid connection means. Thus, the canopy training rack 10 may be installed onto the plant container 30 and then removed for reinstallation over and over again. The canopy training rack 10 typically must be removed from the plant container 30 in order to change the plant inside the invention, harvest fruits or vegetables, trim the plant, or other. When the canopy training rack 10 is attached to the plant container 30 it forms a sturdy rigid connection to the plant container 30 such that the invention, with a mature plant inside, along with soil or growing material in plant container 30, may be moved by simply grabbing the canopy training rack 10 portion. Thus, plaint container connection means 20 must provide holding force that is at least equal to the full weight of invention with a mature plant inside along with soil or growing material, which could be as much as about 90 pounds. The best mode plant container connection means 20 provides at least 100 pounds of holding force when connected to plant container 30.

Plant container 30 comprises: a cylindrical conical member 31, a bottom 32, water drainage holes 34, soil retention ridges 35, a wide brim 38, and wide brim support ridges 39. Plant container 30 is a generally cylindrical member 31 with a closed end 32 on bottom and an open end on top. Closed end bottom 32 is a flat circular member that connects with the bottom end of cylindrical conical member 31, which is also circular with similar diameter to that of bottom 32. Plant container 30 is also conical in that its generally cylindrical member 31 extends upwards at an outward angle towards the open top of the plant container 30. Plant container 30 is wider at the top than at the bottom. Plant container 30 is a flowerpot member used to hold soil or other growing medium therein. A plant is then planted into said soil or other growing medium where the plant then grows and matures to produce fruit or vegetables. Plant container 30 is about 1.5° in height. Plant container 30 is made of semi-rigid material that is strong and tough to withstand the elements for extended periods and remain sturdy to hold the at least 100 pounds of plant and growing medium without breaking or cracking.

Plant container 30 is impermeable and water tight except for water drainage holes 32. Water drainage holes 34 are rectangular or square shaped holes or voids in the cylindrical conical member 31 at the bottom. Water drainage holes 34 function to drain excess water or nutrient solution from the plant container 30. If too much water or nutrient solution pools in the bottom of plant container 30, a fungus or other biological material could develop that harms the plant or its roots. In best mode, water drainage holes are about 2″ by 2″ in size and are placed at the bottom most portion of the cylindrical conical member 31. In best mode there are six drainage holes 34 evenly spaced around the perimeter of bottom member 32.

Soil retention ridges 35 are necessary to keep soil or growing material from draining out of the plant container 30 along with water as it drains through the water drainage holes 34. Soil retention ridges are integral wall members that protrude perpendicularly upwards from the upper surface of bottom member 32 just in front of water drainage holes 34. In best mode, soil retention ridges protrude at least 0.5″ from the bottom 32 and are contoured around drainage holed 34 to best block soil from draining through drainage holes 34. At least one ridge 35 is required for each drainage hole 34.

Wide brim member 38 sits on top of cylindrical conical member 31. Wide brim 38 is shaped somewhat like a flat ring. The inner diameter of the flat ring shape is connected to the upper portion of conical member 31 to form a solid impermeable connection. Both of these members are round and have similar diameters in order to connect properly. Wide brim is further supported into this position by support ridges 39. Support ridges 39 are integral wall members that extend radially outward from the outer surface of cylindrical conical member 31, at the upper most portion, to connect with and form integral wall members with bottom surface of wide brim 38. There are multiple support ridges evenly spaced around the brim 38 of the top of plant container 30. In best mode support ridges 39 are spaced about every 3-4″ around brim 38 and there are about 16-24 ridges 39 supporting wide brim 38. Support ridges 39 and wide brim 38 have a similar wall thickness to that of conical cylindrical member 31.

Wide brim 38 has flat ring section that is at least 2″ wide. The wider the brim 38 of a flowerpot plant container 30 the more space there is to grab onto or to get a hold of. A wide brim 38 of at least 2″ wide is an aspect that is necessary to create the rigid sturdy connection with canopy training rack 10 as discussed below. Further, wide brim 38 is not quite flat because it extends downward radially outwards from top of cylindrical conical member 31. The outer edge of wide brim 38 sets below its inner edge. Thus, the cross section of wide brim 38 is not horizontal but rather is at a downward angle. In best mode, wide brim 38 extends downward at an angle that is about 50 degrees from horizontal. This angle was chosen because it helps provide a sturdy connection with plant training canopy 10 with great vertical connection strength as well as good horizontal connection strength.

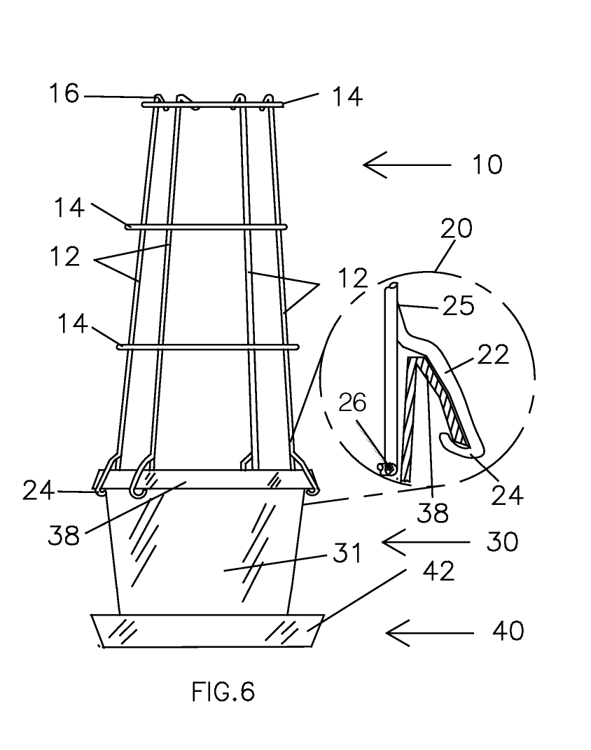

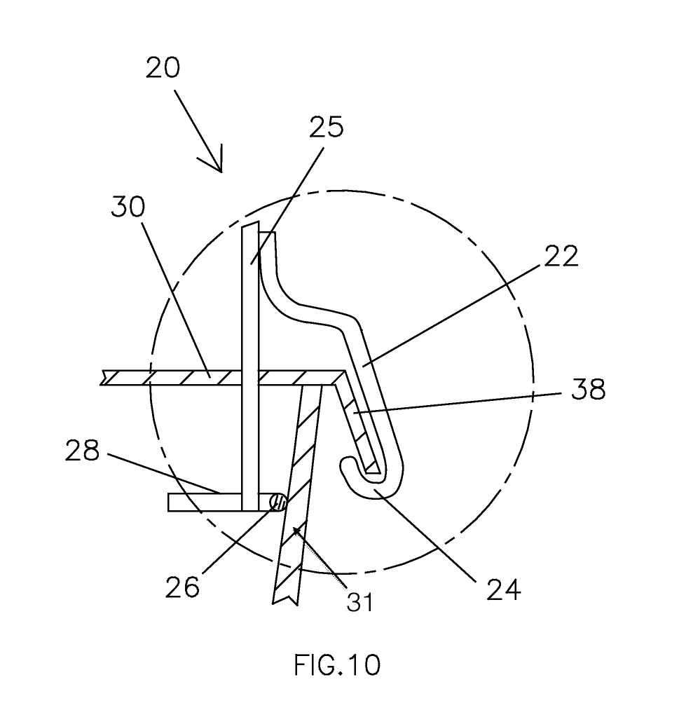

Plaint container connection means 20, wide brim 38, and wide brim support ridges 39 provide the reversibly attachable rigid connection means described above. This is the sturdy connection means between plant container 30 and canopy training rack 20 that provides at least 100 pounds of holding force when connected properly. See FIGS. 6 and 10 for blow-up depictions of best mode reversibly attachable rigid connection means.

Plant container connections means 20 is an element of canopy training rack 10. Best mode plant container connection means 20 comprises: a wide brim parallel member 22, a hook member 24, a wide brim parallel member attachment means 25, a clamp ring 26, and a clamp ring attachment means 28. There is one plant container connection means 20 per vertical support member 12. In best mode, each canopy training rack 10 has four vertical support members 12 and four plant container connections members 20. Plant container connection means 20 is an assembly of intricately shaped members made from the same tubular material as support members 12 and 14. Wide brim parallel member 22 is a long straight member that is positioned at an angle to match that of wide brim 38. Thus, in best mode, wide brim parallel member is position at about a 50-degree angle from horizontal in a downward outward direction from vertical centerline of plant container 30. Wide brim parallel member 22 must have length slightly longer than the width of wide brim 38. Thus, wide brim parallel member 22 has length of at least 2″.

The upper end of wide brim parallel member 22 is permanently and rigidly connected to a vertical support member 12. This connection is accomplished by wide brim parallel member connection means 25. Wide brim parallel member attachment means 25 consists of a bent piece of tubular material shaped like an “S”. One end of the S-shape is connected to wide brim parallel member 25. In best mode, this end of the S-shape is integral to and is the same piece tubular member that is the wide brim parallel member 22. The other end of the S-shape is welded, fused, or glued to a vertical support member 12.

Hook member 24 is a member shaped like a hook. The base of the hook shape 24 is connected with the other end or bottom end of wide brim parallel member 22. In best mode, 22 and 24 are made from the same piece of tubular material. The hook on hook member 24 must have a turned section that is at least 0.5″ in length. Thus, the straight section of 24 opposite to that connected to wide brim parallel member 22 must have a length of at least 0.5″. This length is required for the hook member 24 to keep a firm hold onto wide brim 38 when the canopy training rack 10 is snapped into position. Members 22 and 24 are position radially around canopy 20. The open portion of hook 24 is positioned on the inside with the wide brim parallel member 22 positioned on the outside of this radial placement.

Clamp ring 26 is a rigid ring shaped member made from the same tubular material as support members 12 and 14. Clamp ring 26 has a larger diameter than that of any horizontal member 14. Clamp ring 26 is permanently and rigidly connected to vertical support members 12 at the very bottom of support members 12. Clamp ring 26 lies horizontally along with horizontal support members 14. In best mode, clamp ring is attached to members 12 by welding, fusing, or gluing. The outer diameter of clamp ring 26 is specially design and manufactured to create a slip fit with slight clearance between the inner diameter of plant container 30 at a position on plant container 30 that coincides with that of clamp ring 26 when hook member 24 is properly snapped onto wide brim 38. Thus, clamp ring 26 is sized and positioned onto canopy 10 in such a way so that when canopy 10 is properly snapped onto plant container 30 with hook members 24 properly hooked onto wide brim 38, there is a precise fit between the outer diameter of clamp ring 26 and the inner diameter of plant container 30. This clearance is designed to give a good and tight “friction fit” or “slip fit” between these members.

There are two primary force components of reversibly attachable rigid connection means—vertical and lateral components. The first is the vertical component of attachment and lifting force. The hook members 24 are primarily responsible for this component. When canopy training rack 10 is installed properly onto plant container 30, hook member 24 actually hooks over wide brim 38 of plant container 30. The placement of 24 over 38 is physically possible because of the slight flexibility of plant container 30 material and specifically the material of wide brim 38. Wide brim 38 is made if semi rigid material that is slightly flexible. Canopy training rack 10 is made of rigid material that is substantially more rigid than wide brim 38 material. When canopy training rack 10 is positioned concentrically with plant container 30 as viewed from the top, and then pushed downward, the canopy training rack 10 literally snaps onto plant container 30, where hook member 24 then literally hooks around the lower edge of wide brim 38. The snap effect occurs when the inner surface of hook member 24 forces in wide brim 38 as the canopy training rack 10 is being pushed downward onto plant container 30. When this occurs, hook 24 causes brim 38 to flex inward until hook member 24 clears the bottom edge of brim 38, when brim member 38 then snaps outward, becoming hooked by hook member 24.

Wide brim support ridges 39 work against the flexibility of wide brim 38. At the points on the upper surface of wide brim 38 near brim support ridges 39, there is very little flexibility of wide brim 38. Thus, hook member 24 must be position in between wide brim support ridges 39 before being pushed downward to snap into place.

The clamp ring slip fit connection is primarily responsible for the lateral hold force component of the reversibly attachable rigid connection means. The firm connection is a result of a squeeze connection or squeezing effect of wide brim support member 22 and clamp ring 26 squeezing onto wide brim 38 and cylindrical conical member 31 of plant container 30. As can be seen from the cross-section depictions in FIGS. 6 and 10, with this design, the more flexible material of plant container 38 and 31 gets wedged and squeezed between canopy members 26 and 22. When these members are sized according the above and snapped into place correctly, the connection provides very sturdy lateral support. Enough so that one may simply grab onto the top of canopy training rack 10 with fully matured pant inside, and move the plant and device around rather easily without any play in the connect between the canopy 10 and plant container 30.

It should be noted that the round configurations of clamp ring 26 and plant container 30 was specifically chosen for this slip fit friction connection. A round slip fit friction connection provides more holding force than any other shaped slip fit friction connection including for instance a rectangular shaped slip fit friction connection.

To remove canopy training rack 10 from plant container 30, one must pull hook member 24 down, while pushing in laterally on wide brim 38. Wide brim 38 must be pushed in enough to provide clearance for the hook member 24 to slide upwards without re-hooking wide brim 38. This must be done successively to all plant container connection means individually until the canopy training rack 10 is completely disconnected from plant container 30.

Water saucer 40 comprises: a water saucer cylindrical conical member 42, a water saucer bottom member 44, and water saucer bottom ridges 46. Water saucer 40 is a generally cylindrical member 42 with a closed end 44 on bottom and an open end on top. Closed end bottom 44 is a flat circular member that connects with the bottom end of saucer cylindrical conical member 42, which is also circular with similar diameter to that of bottom 44. Water saucer 40 is also conical in that its generally cylindrical member 42 extends upwards at an outward angle towards the open top of water saucer 40. Water saucer 40 is wider at the top than at the bottom. Water saucer 40 is a saucer member used to hold water or growing solution that has drained from the plant container 30 through drainage holes 34. By pooling this solution in water saucer 40 and not letting it escape the container, the plant may absorb or reabsorb this liquid into the growing medium through the drainage holes 34 through a wicking action which naturally occurs when the plant's roots get dry.

Water saucer bottom ridges 39 are integral wall members protruding perpendicularly from the bottom surface of water saucer bottom member 44. Water saucer bottom ridges 39 have wall thickness similar to that of water saucer bottom member 44. Water saucer bottom ridges 39 protrude from the bottom surface of water saucer bottom member 44 by about ¼″. Water saucer bottom ridges 39 function to provide a better grip of water saucer 40 and of the overall device with plant inside when the surface of the balcony, porch, patio, sidewalk, deck, or ground becomes wet.

1. (canceled)

2. A plant container with canopy training rack comprising:
a canopy training rack, comprising: at least three vertical support members, at least three horizontal support members, and a plant container connection means; and
a plant container, comprising: a cylindrical conical member, a bottom, and a wide brim, wherein,
said vertical support members are straight rigid tubular members that extend vertically upwards from said wide brim at a slight angle inward towards the vertical centerline of said plant container to form a Christmas tree shaped cage atop said plant container,
said horizontal members are rigid ring shaped members made from tubular material that are permanently and rigidly connected to vertical support members to help form said Christmas tree shaped cage atop said plant container, such that each ring-shaped horizontal member has a different overall diameter, where larger diameter horizontal ring members lie below smaller diameter ring members with the largest ring on the bottom and the smallest ring on the top of said canopy training rack where said horizontal members are positioned concentrically in the plan view,
said cylindrical conical member is a generally cylindrical member with a closed end on bottom, which is said bottom, and an open end on top, said bottom being a flat circular member that connects with the bottom end of said cylindrical conical member, which is also circular with similar diameter, to form a solid impermeable cylindrical conical container used to hold a plant and growing medium,
said cylindrical conical member is also conical in that its generally cylindrical shape extends upwards at an outward angle towards the open top of said plant container which is wider at the top than at the bottom,
said wide brim sits on top of said cylindrical conical member and is shaped like a flat ring with inner diameter connected to the upper portion of said conical member to form a solid impermeable connection,
said wide brim extends radially downward from the top of said cylindrical conical member at an angle that is about 50 degrees from horizontal, radially, where the width of flat ring member is at least two inches wide,
said plant container connections means comprises: a wide brim parallel member, a hook member, a wide brim parallel member attachment means, a clamp ring, and a clamp ring attachment means, where there is one said wide brim parallel member, one said hook member, and one said wide brim parallel member attachment means per said vertical support member, wherein,
said wide brim parallel member is a straight tubular member at least two inches in length that is positioned at about a 50-degree angle from horizontal in a downward outward direction from vertical centerline of said plant container and is permanently and rigidly connected to one said vertical support member by said wide brim parallel member attachment means,
said wide brim parallel member attachment means consists of a bent piece of tubular material shaped like an “S” where one end of the S-shape is integral to or connected to the upper end of said wide brim parallel member and the other end of the S-shape is welded, fused, or glued to one said vertical support members,
said hook member is hook shaped with the base of the hook shape integral to or connected to the lower end of said wide brim parallel member and the hook functions to hook onto said wide brim when said canopy training rack is attached to said pant container,
said hook member has a turned end hook member section that is at least one half inch in length,
all said hook members are position radially around the vertical center line of said plant container with the open portion of hook positioned on the inside and said wide brim parallel member portion positioned on the outside of this radial placement,
said clamp ring is a rigid ring shaped member that is permanently and rigidly connected to the bottom ends of all said vertical support members in a horizontal position parallel to said horizontal members by said clamp ring attachment means, where the outer diameter of said clamp ring is sized to create a slip fit with exact clearance between the inner diameter of said plant container at a position on said plant container that coincides with that of said clamp ring when said hook members are properly snapped onto said wide brim, and
said clamp ring attachment means comprises welding, fusing, or gluing said clamp ring to the bottom ends of said vertical support members.

3. A plant container with canopy training rack as recited in claim 2 wherein said canopy training rack further comprises: at least three plastic cover dome support members, wherein, said plastic cover dome support members lie on top of said vertical support members, above all said horizontal support members, where there is one plastic cover dome support member per vertical support member and each plastic cover dome support member is hook-shaped member where said hook shape faces downward so that plastic material may slide over the bottom of this hook shape without snagging, puncturing, or tearing the plastic material.

4. A plant container with canopy training rack as recited in claim 2 wherein said plant container further comprises: at least three water drainage holes and at least three soil retention ridges, wherein,
said drainage holes are holes or voids in said cylindrical conical member at the bottom portion of said cylindrical conical member through which pooling liquid in the bottom of said plant container may drain, and
said soil retention ridges are integral wall members that protrude perpendicularly upwards from the upper surface of said bottom member to block or damn the area of said bottom just in front of each said water drainage hole and function to hold in soil or growing medium from draining out of said plant container along with the draining of the pooling liquid.

5. A plant container with canopy training rack as recited in claim 2 wherein said plant container further comprises: at least ten wide brim support ridges, wherein, said wide brim is further supported at this 50-degree from horizontal downward radial position by said wide brim support ridges which are integral wall members that extend radially outward from the outer surface of said cylindrical conical member, at the upper most portion, to connect with and form integral wall members with bottom surface of said wide brim, where said support ridges are evenly spaced around said wide brim.
